(19) United States
(12) Patent Application Publication
(10) Pub. No.: US 2003/0065515 A1
(43) Pub. Date: Apr. 3, 2003

(54) Information processing system and method operable with voice input command

(76) Inventor: Toshikazu Yokota, Kariya-city (JP)

Correspondence Address: LAW OFFICES OF DAVID G. POSZ, 2000 L STREET, N.W., SUITE 200, WASHINGTON, DC, 20036, US

(21) Appl. No.: 10/195,099

(22) Filed: Jul. 15, 2002

(30) Foreign Application Priority Data
Oct. 3, 2001 (JP) 2001-307540

(51) Int. Cl. G10L 21/00

(52) U.S. Cl. 704/270

(57) ABSTRACT

In a navigation system, when a command of a voice recognizable type is input manually, a user is notified, by displaying an application screen and a command on a display device, that such a command can be input in voice. For instance, when a menu screen is displayed in response to manual inputs of commands, the display device provides a visual guidance by displaying a message “You may input voice messages. Please voice menu screen in a map screen.” In addition or alternatively, a voice guidance may be provided by sounding the same message from a speaker. The user thus notified can input commands in voice from next time on while eliminating manual inputting operation through a switch device or the like.

### CROSS REFERENCE TO RELATED APPLICATION

This application is based on and incorporates herein by reference Japanese Patent Application No. 2001-307540 filed Oct. 3, 2001.

### FIELD OF THE INVENTION

The present invention relates to an information processing system and method that are operable with voice commands inputted by users of the system.

### BACKGROUND OF THE INVENTION

It is proposed to construct an information processing system such as a navigation system so that it receives user's various operation commands interactively and operates to execute predetermined operations corresponding to the input commands. This system generally uses a command input device such as a touch switch device, a remote control device or a key device, which allows inputting various operation commands manually by users.

In addition to the manual input device, a voice input device is proposed for a car navigation system from the standpoint of driving safety, because the voice input device does not require attention of a driver to the input device itself or display screen. Thus, it is most preferred that the system accepts at least some of the user's input commands by way of both a voice recognition method and other method.

However, in the case of voice inputs, users must always remember the voice input commands. Even if the voice input commands are defined in a users operation manual or the like, it is not practical to refer to the manual each time the user tries to input voice commands.

### SUMMARY OF THE INVENTION

It is therefore an object of the present invention to provide an information processing system and method that enable a voice input device to be used more frequently without difficulty.

According to the present invention, an information processing system such as a navigation system receives commands manually and performs predetermined processing in response to the input commands. The system also checks whether an input command applied externally by a user is a predetermined voice-recognizable command, and outputs a notification that the input command is a type that is recognizable even if input in voice.

Preferably, the notification is output audibly or visually, and includes the voice command itself and a condition in which the voice command is recognizable. Outputting of the notification may be selectively enabled or disabled by the user.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an information processing system according to an embodiment of the present invention;

FIG. 2 is a flow diagram showing a voice recognition operation guide in the embodiment;

FIG. 3 is a schematic diagram showing an example of visual guide and voice guide in the embodiment; and

FIG. 4 is a flow diagram showing voice recognition processing in the embodiment.

### DETAILED DESCRIPTION OF THE PREFERRED EMBODIMENT

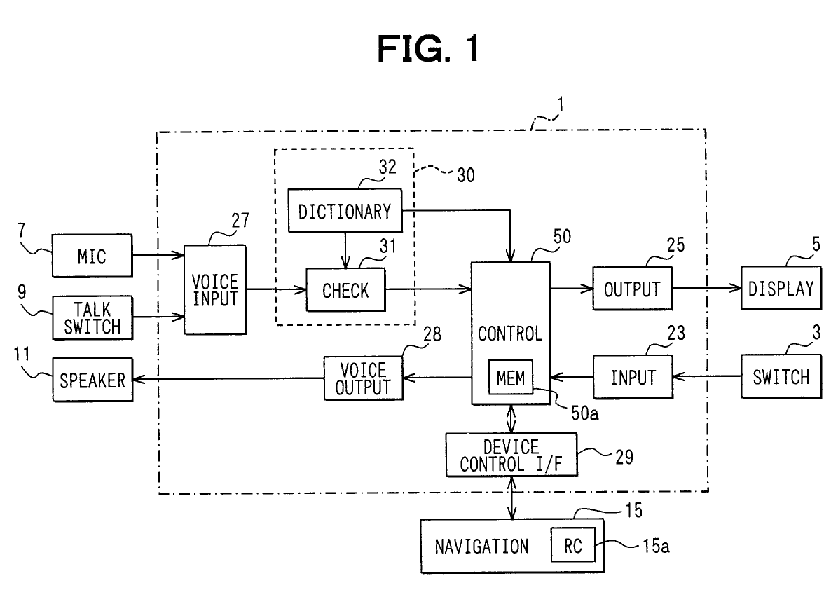

Referring first to FIG. 1, an information processing system including a control device 1 and a navigation device 1 is mounted in a vehicle so that the control device 1 controls the navigation device 15 while interacting with users (mostly a driver) with voice. The control device 1 is connected to a switch device 3, a display device 5, a microphone 7, a talk switch 9 and a speaker 11, in addition to the navigation device 15 that detects the present location of the vehicle and provides a travel route guidance. The switch device 3 is for allowing users to input various commands and data externally by manual operation, and the display device 5 is for displaying images visually. The microphone 7 is for inputting voice commands while operating the talk switch 9, and the speaker 11 is for outputting voice.

The navigation device 15 has, as known in the art, a GPS device for detecting the present position of a vehicle, a CD-ROM or DVD storing route guidance data such as map data, location name data and facility name data, a CD-ROM drive for retrieving data from the CD-ROM, and an operation key device for enabling users to manually input various operation commands. When a user inputs a destination and an operation command for a route guidance to the destination by manipulating the operation key device, the navigation device 15 provides a route guidance by displaying the present location of the vehicle and the recommended travel route toward the destination on a road map on the display device 5. The display device 5 displays not only road maps for route guidance but also many other visual images such as information retrieval menu.

The control device 1 includes a control section 50, an input section 23, an output section 25, a voice input section 27, a voice recognition section 30, a voice output section 28 and a device control interface section 29. The control section 50 is comprised of a microcomputer that includes a CPU, ROM, RAM and the like. The input section 23 is for inputting commands and data applied from the switch device 3. The image output section 25 is for converting digital image data into analog image signals and driving the display device 5 to display images corresponding to the image signals. The voice input section 27 is for converting voice signals applied from the microphone 7 into digital data. The voice recognition section 30 is for recognizing and retrieving keywords (voiced keywords) which a user voiced from voice signals applied from the voice input section 27. The voice output section 28 is for converting digital text data produced from the control section 50 into analog voice signals to drive the speaker 11. The control device interface section 29 is for operatively connecting the navigation device 15 and the control section 50 so that the navigation device 15 and the control section 50 are capable of data communication therebetween.

The talk switch 9 is provided to enable voice input by the microphone 7 only when it is operated. However, if no voice input is detected for a predetermined period after the talk switch 9 is operated to enable voice input, the voice input after this period is not processed in the control device 1. For this operation, the voice input section 27 monitors the time point of operation of the talk switch 9.

The voice input section 27 divides out a certain period of a frame signal, for instance about tens of millisecond period, at every fixed interval and checks whether the frame thus divided out includes voice or only noise without voice, so that characteristic amount of the input voice is analyzed. This checking operation of the voice period or noise period is necessary because the input signal applied from the microphone 7 includes both voice and noise. As an exemplary method for determining the voice period or the noise period, it is known to measure a short-time power of the input signal at every fixed time interval, and check whether the measured short-time power exceeds a predetermined threshold and continues a plurality of times. If the period is determined to be the voice period, the input signal corresponding to that period is applied to the voice recognition section 30.

The voice recognition section 30 includes a check section 31 and a recognition dictionary section 32. The dictionary section 32 stores dictionary data that comprises an ID and a structure of each of a plurality of key words that should be recognized by the control device 1. Those key words are defined as words that users will voice to operate the navigation device 15, etc. The check section 31 checks the voice data applied from the voice input device 27 by comparing the same with the stored data of the dictionary section 32. The check section 31 outputs a recognition result to the control section 50. The recognition result is defined as the ID of a key word that has the highest recognition rate.

The control section 50 finalizes the recognition results and executes subsequent processing that may include sending the data to the navigation device 15 through the interface 29 and instructing the navigation device 15 to execute predetermined processing when the recognition result is finalized. For instance, the navigation device 15 may be instructed to set a travel destination for navigation processing in response to the input of destination from the control section 50. By using the voice recognition section 30 as described above, commands such as travel destination can be input by voicing without manually operating the operation switch device 3 or the remote controller 15a of the navigation device 15. The control section 50 also outputs the recognition results applied from the voice recognition section 30 to the voice output section 28 as text data so that each recognition result may be voiced from the speaker 11 for confirmation by the user or for other purposes.

The recognition result applied from the voice recognition section 30 to the control section 50 may be more than one highly possible patterns or only one highest possible pattern among the highly possible patterns. In the description to follow, it is assumed that only one highest possible pattern is applied to the control section 50 unless otherwise specified.

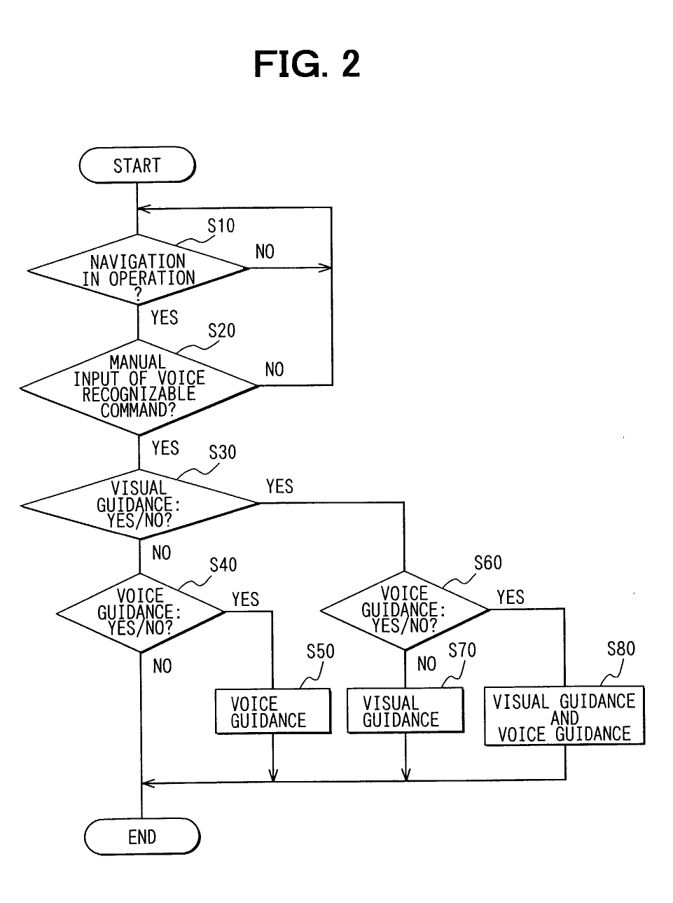

The control device 1, particularly control section 50 is programmed to execute the processing shown in FIG. 2 for voice recognition.

It is checked first at step S10 whether the navigation device 15 is in operation. In this embodiment, the navigation must be in operation, because it is notified to a user that a command can be also input in voice if the command manually input through the switch device 3 or the remote controller 15a is of such a predetermined voice recognizable type. If the navigation device 15 is in operation (YES at S10), it is further checked at step S20 whether a command that is the predetermined voice recognizable type is input manually through the switch device 3 or the like. The voice recognizable type is defined as a command for displaying a menu screen, a command for selecting travel route setting operation or information searching operation, a command for setting a destination on a travel route setting screen and other similar commands.

If the manually input command is a voice recognizable type (YES at S20), it is notified to a user that the command which was input manually can also be input in voice. This notification or guidance may be set selectively by a user, that is, it may be provided only when so selected by a user. To enable this selective setting, a setting screen is displayed on the display device 5 when the switch device 3 or the like is manually operated in a predetermined manner or sequence. The setting screen displays selection items, “VISUAL GUIDANCE SETTING : YES/NO” and “VOICE GUIDANCE SETTING : YES/NO” thereon as a part of voice recognition operation guidance so that YES or NO may be selected on the screen by a user. If “YES”is selected regarding the visual guidance setting, an operation mode for providing a guidance for the visual guidance setting by the display device 5 is set. Similarly, if “YES” is selected regarding the voice guidance setting, an operation mode for providing guidance for the voice guidance setting by the speaker 11 is set. If “YES” is selected for both settings, visual guidance and voice guidance are provided on the display device 5 and the speaker 11, respectively.

It is checked at step S30 whether “YES” is selected for the visual guidance setting on the display device 5. If “NO” is selected (NO at step S30), it is further checked at step S40 whether “YES” is selected for the voice guidance setting on the display device 5. If “NO” is selected (NO at step S40), the processing ends without guidance for inputting voice commands. If “YES” is selected for the voice guidance setting (YES at step S40), only voice guidance for inputting voice commands is provided from the speaker 11 at step S50.

If “YES” is selected for the visual guidance setting (YES at step S30), it is further checked at step S60 whether “YES” is selected for the voice guidance setting in the same manner as at step S40. If the check result at step S60 is NO and YES, only the visual guidance is provided at step S70 by the display device 5 and both the visual guidance and the voice guidance are provided by the display device 5 and the speaker 11, respectively.

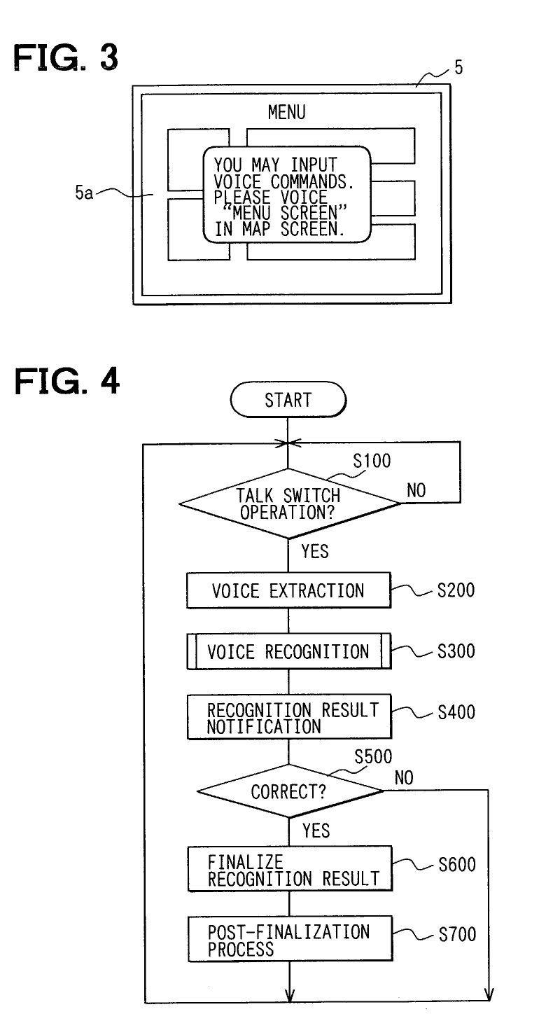

In the case of the visual guidance, the control section 50 controls the screen output section 25 to display an application screen 5b and a message (command) on a display screen 5a of the display device 5 as shown in FIG. 3. For instance, if the switch device 3 or the like is manipulated to display a menu screen, the display device 5 displays a message, that is, “You may input voice commands. Please voice “menu screen” in map screen.” In the case of the voice guidance, the control section 50 controls the voice output section 28 to voice the same message provided by the display device 5 from the speaker 11.

When it is desired to display a menu screen, for instance, a display screen can be changed by inputting a command of “menu screen” in various conditions. In this embodiment, map screen display condition is selected as one of the exemplary conditions for displaying the menu screen, because the map screen is displayed most often as an initial screen in the navigation system.

A user who is thus notified and learns that voice commands can also be accepted is enabled to input commands (for instance, “menu screen”) in voice under a condition that the map screen is displayed from next time on.

The control section 50 is further programmed to execute the voice recognition processing shown in FIG. 4.

It is first checked at step S100 whether the talk switch is operated (turned on). If YES, voice component is extracted at step S200. In this voice extraction step, the voice input section 27 is controlled to determine whether the output data produced from the microphone 7 is in the voice period or the noise period and extract data in the voice period. This extracted data is output to the voice recognition section 30. Then at step S300, the extracted data is subjected to voice recognition process. The result of this recognition process is returned in voice from the speaker 11 through the voice output section 28 and also displayed on the display device 5 through the screen output section 25 at step S400, so that the user may input his/her agreement or disagreement to the recognition result through the switch device 3 or the microphone 7.

It is then checked at step S500 whether the user agreed to the recognition result (correct recognition). If the recognition result is incorrect (NO at step S500), the processing returns to step S100 to repeat the above steps. If the recognition result is correct (YES at step S500), the recognition result is finalized or fixed at step S600 and a post-finalization process is executed at step S700. If the finalized recognition result is “menu screen,” the process at step S600 includes outputting various data related to the menu screen to the navigation device 15 through the device control interface 29.

According to the above embodiment, the control device notifies that the manually input command is also available in voice if it is so. As a result, the user so notified can input commands in voice in place of manually operating switches from the next time on, and simplify command inputting operation.

Further, because the application screen for a voice command inputting and the command therefor are notified, the user learns in detail in what condition and how the voice command can be input. This results in a helpful guidance for users who are not so skilled in voice command inputting operation.

Once a user get skilled in the voice command inputting operation, repetition of the same guidance will become annoying. However, this disadvantage can be overcome by selecting “NO” if the guidance setting screen is displayed on the display device 5 so that selection of “NO” may be checked at steps S30, S40 and S50 in FIG. 2.

The above embodiment may be modified in many ways including the following modifications.

(1) For the case that the user once learned the command for voice inputting operation but cannot remember the command, it is preferred to store the history of voice commands in a memory 50a of the control section 50 or in an external memory so that the stored command may be retrieved upon user's request. For instance, a message such as “A menu screen and a voice input were effected in a map screen.” can be displayed as a history. The number of voice commands actually inputted may be limited to a predetermined number so that only a plurality of the latest ones may be stored while canceling older ones and displayed in the order from the latest one.

(2) The control device 1 may be used in association with various devices other than the car navigation device. Such devices include an air conditioner device, an audio device, a power window device, a rear view mirror device and the like. If it is used in association with an air conditioner device, the voice command inputting may be effected for variably setting a target compartment temperature, selecting an air conditioning mode (cooling, heating, dehumidifying) or selecting air flow direction.

What is claimed is:

1. An information processing system that performs predetermined processing in response to input commands, the system comprising:
check means for checking whether an input command applied externally by a user is a predetermined voice-recognizable command; and
output means for outputting a notification that the input command is recognizable even if input as a voice command.

2. The information processing system as in claim 1, wherein the output means includes at least one of a speaker and a display device that output the notification audibly or visually, respectively.

3. The information processing system as in claim 1, wherein the notification includes the voice command itself and a condition in which the voice command is recognizable.

4. The information processing system as in claim 1, further comprising:
selection means for enabling selection of execution or non-execution of outputting of the notification by the user.

5. The information processing system as in claim 1, further comprising:
memory means for storing the voice command that is input by the user so that the stored voice command is output as a part of the notification.

6. The information processing system as in claim 1, further comprising:
a switch device for inputting predetermined operation commands manually by the user;
a navigation device that is operated in response to the predetermined operation commands input from the switch device,
wherein the voice command is one of the predetermined operation commands.

7. An information processing method that performs predetermined processing in response to input commands, the method comprising steps of:
checking whether an input command applied manually by a user is a predetermined voice-recognizable command; and
outputting a notification that the input command is a type that is recognizable even if input in voice.

8. The information processing method as in claim 7, wherein the outputting step outputs the notification audibly or visually through a speaker or a display device, and the notification includes the voice command itself and a condition in which the voice command is recognizable.

9. The information processing method as in claim 7, further comprising:
enabling selection of execution or non-execution of outputting of the notification by the user.

10. The information processing method as in claim 7, wherein the command the voice command is one of predetermined operation commands input by the user for operating a navigation device.
